(19) United States
(12) Patent Application Publication
(10) Pub. No.: US 2010/0058167 A1
(43) Pub. Date: Mar. 4, 2010

(54) Displaying Subscribable Content

(75) Inventors: Jane T. Kim, Seattle, WA (US); Oliver Wallace, Redmond, WA (US); Reza A. Nourai, Kirkland, WA (US); Miladin Pavlicic, Sammamish, WA (US); Benjamin N. Truelove, Lynnwood, WA (US); Walter V. von Koch, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/198,649

(22) Filed: Aug. 26, 2008

(51) Int. Cl. G06F 17/00

(52) U.S. Cl. 715/234

(57) ABSTRACT

Live update display techniques associated with displaying subscribable content live consumed outside of a Web page are described. In at least some embodiments, information received on the device is used to determine that subscribable content from a Web source has been updated. This information, however, may not represent the source to be used for consumption. Therefore, the content to be used for consumption that includes display markup can be retrieved from a source other than the device, such as a display Web page, and used to display subscribable content on the device.

### BACKGROUND

Web publishers can make content from a web page available outside of the conventional Web page. Today, this is primarily done through enabling an RSS feed or a gadget of some type. The problem with these technologies is that they require the publisher to create different representations of the content, rather than take advantage of Web page infrastructure that is in place today.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments describe display techniques for actively displaying subscribable content live consumed outside of a Web page. In at least some embodiments, information received on a device is used to determine that subscribable content from a Web page or other Web source has been updated. This information, however, may not represent the source to be used for consumption. Therefore, the content to be used for consumption that includes display markup can be retrieved from a source other than the device, such as a display Web page, and used to display subscribable content on the device. This frees content providers (e.g., publishers, etc.) from necessarily relying on RSS Web feeds or gadgets to provide subscribable content to users for display and allows users to quickly access and display this content.

### BRIEF DESCRIPTION OF THE DRAWINGS

FIG. 1 illustrates an example operating environment in which live update display techniques can be implemented, in accordance with one or more embodiments.

FIG. 2 illustrates an example display system in which the described live update display techniques can be implemented in accordance with one or more embodiments.

FIG. 3 illustrates a flow diagram that describes steps in a method in accordance with one or more embodiments.

FIG. 4 illustrates an example embodiment for implementing the described live update display techniques.

FIG. 5 illustrates an example embodiment for implementing the described live update display techniques.

FIG. 6 illustrates a flow diagram that describes steps in a method in accordance with one or more embodiments.

FIG. 7 illustrates a Web browser user interface in accordance with one or more embodiments.

FIG. 8 illustrates a Web browser user interface in accordance with one or more embodiments.

FIG. 9 illustrates a Web browser user interface in accordance with one or more embodiments.

FIG. 10 illustrates an example computing device that can be used to implement various described embodiments.

### DETAILED DESCRIPTION

Overview

Display techniques are described for actively displaying subscribable content live from a Web page. In at least some embodiments, information received on a device is used to determine that subscribable content from a Web page or other Web source has been updated. This information may not represent what the subscribable content provider intended to be displayed to the user. Subscribable content that includes display markup can then be retrieved from a source other than the device, such as a display Web page, and used to display the content on the device live from the display Web page as the subscribable content provider intended.

To accomplish this, in at least some embodiments HTML code of a Web page with subscribable content is parsed by a Web browser or other suitable application to discover either subscribable content or a link to another Web page providing the subscribable content. Furthermore, HTML code of one of these Web pages is also parsed to discover a link to a display Web page with display markup for displaying the updated subscribable content live.

In the discussion that follows, a section entitled “Operating Environment” describes but one environment in which the various embodiments can be employed. Following this, a section entitled “Displaying Subscribable Content” describes embodiments in which subscribable content can be actively displayed live from a Web page. Next, a section entitled “Live Web Slice Display-Example” describes an example embodiment in which a Web slice associated with a social networking Web site can be actively displayed on a Web browser tool bar live. Last, a section entitled “Example Device” describes an example computing device that can be used to implement various described embodiments.

Operating Environment

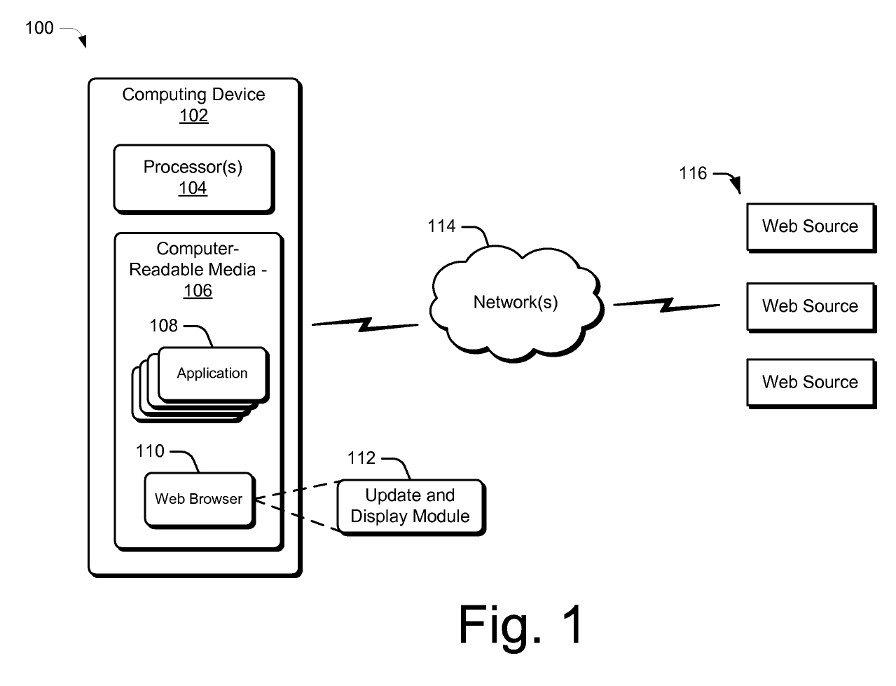

FIG. 1 illustrates an operating environment in accordance with one or more embodiments, generally at 100. Environment 100 includes a computing device 102 having one or more processors 104, one or more computer-readable media 106 and one or more applications 108 that reside on computer-readable media 106 and which are executable by processor(s) 104. Applications 108 can include any suitable type of application such as, without limitation, reader applications, e-mail applications, instant messaging applications, and a variety of other applications. In this regard, an application in the form of a Web browser 110 can include or otherwise make use of an update and display module 112 to implement the described live update display techniques. For instance, update and display module 112 can be utilized by Web browser 110 and/or one or more of applications 108 to display subscribable content live from a Web page.

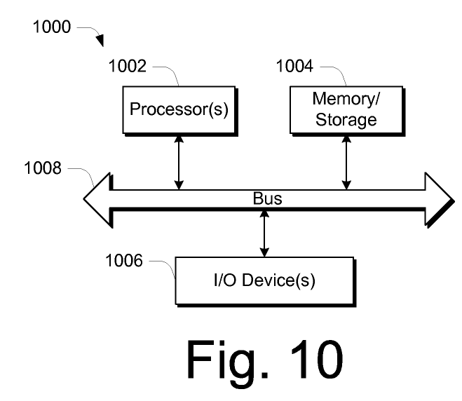

Computer-readable media 106 can include, without limitation, all forms of volatile and non-volatile memory and/or storage media that are typically associated with a computing device. Such media can include ROM, RAM, flash memory, hard disk, removable media and the like. One specific example of a computing device is shown and described below in FIG. 10.

In addition, environment 100 includes one or more networks 114 and one or more Web sources 116 from and to which content can be received and sent. As such, computing device 102 and one or more Web sources 116 are communicatively linked via one or more network(s) 114. Network(s) 114 can include, without limitation, any combination of the Internet, one or more local area networks (LANs), wide area networks (WANs), cellular voice/data networks or the like accessible via any combination of wired and/or wireless network communication pathways.

Computing device 102 can be embodied as any suitable computing device such as, without limitation, a desktop computer, a portable computer, a handheld computer such as a personal digital assistant (PDA), cell phone and the like.

Having considered an example operating environment, consider now a discussion in which subscribable content can be actively displayed live from a Web page.

Displaying Subscribable Content

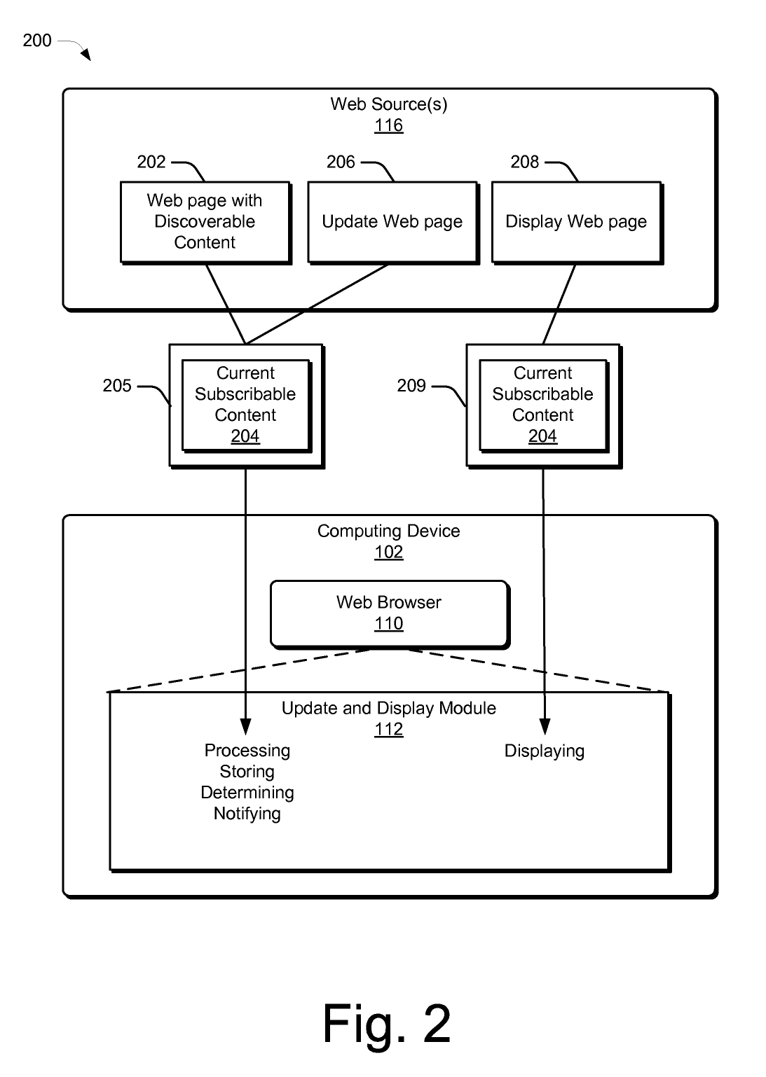

FIG. 2 illustrates an example display system 200 in which the described live display techniques can be implemented, in accordance with one or more embodiments. For discussion purposes, system 200 is illustrated and described in the context of the example operating environment of FIG. 1. However, it is to be appreciated and understood that system 200 can be implemented independently of any particular operating environment.

System 200 includes Web source(s) 116 and computing device 102 which, as described above, are communicatively linked via network(s) 114 (not shown). Web source(s) 116 includes a Web page 202 providing discoverable content to which a user can subscribe. More particularly, Web page 202 includes annotation, such as HTML markup, which can be parsed to discover and access subscribable content on Web page 202. To discover and access the subscribable content, Web browser 110 can parse annotation of Web page 202 to discover and download an instance 205 of current subscribable content 204. Web browser 110 can then store the downloaded instance on computer readable media 106 (not shown). In at least some embodiments, Web browser 110 utilizes the functionality of update and display module 112 to accomplish this.

Since instance 205 is a current version of the subscribable content, it may represent updated subscribable content. However, as will be understood and appreciated by those skilled the art, instance 205 may include additional extraneous content other than the subscribable content from Web page 202 or Web page 206 as well. For example, if the subscribable content on Web page 202 is updated by a publisher or other content provider, the current, updated version of this content along with aggregated extraneous content other than the subscribable content is available as instance 205. Ways in which the subscribable content on Web page 202 can be updated include, without limitation, adding, removing and/or altering non-display information or display information of the subscribable content. Non-display information can include any type of information other than display information. As such, non-display information can include a reference to a location such as a display Web page providing display information for the subscribable content. Consider for example a scenario where the content is associated with a social networking Web site. Non-display information such as contact information, pictures, quotes, links to Web pages or the like for a particular user profile account might be updated by the account owner and/or by the Web site publisher. Additionally or alternatively, display information such as display markup effecting how the non-display information is displayed on the social Networking Web site might be updated.

Web source(s) 116 also includes an update Web page 206 which can be associated with the same Web source as Web page 202 or a different Web source than Web page 202. Web page 206 can also provide instance 205 of current subscribable content 204 in addition to, or instead of, Web page 202. More particularly, Web page 206 includes annotation, such as HTML markup, which can be parsed by Web browser 110 or some other suitable application to discover instance 205. As such, Web page 206 is effectively an alternate source for current subscribable content 204. Therefore, in at least some embodiments, rather than providing current content 204 itself, Web page 202 can include annotation with a link to Web page 206 in the form of a Uniform Resource Locator (URL) for Web page 206. Once Web browser 110 parses the annotation of Web page 202 to discover the URL, it can access Web page 206. Web browser 110 can then parse the annotation of Web page 206 to discover and download instance 205.

Once instance 205 is downloaded onto computing device 102, it can be processed (e.g., parsed and/or sanitized) for a variety of reasons. For example, as will be appreciated and understood by those skilled in the art, processing may be performed for security reasons to remove potentially malicious content. Alternatively or additionally, processing may be performed to remove extraneous content aggregated with current subscribable content 204. As a result of this processing, display information such as script, ActiveX™ and the like, if present, is stripped or otherwise removed from instance 205 before being stored. As such, the remaining processed information (PI) not stripped or otherwise removed is not likely to be sufficient to allow the current subscribable content to be displayed or otherwise consumed in the way its provider (e.g., the publisher) intended. Consider for example a scenario where current subscribable content 204 of instance 205 includes interactive display markup for a social networking Web site. This interactive display markup might allow a user to interact with the site by updating their profile or leaving messages on other user profiles. This markup might also include certain associated content not actually displayed to a user, such as, without limitation, refresh parameters, update frequency parameters and the like. Once this interactive display markup is removed during processing however, these interactive features may not be available to the user.

Continuing, using the PI Web browser 110 can determine if current subscribable content 204 represents updated subscribable content. More particularly, Web browser 110 can compare the PI to previously processed information (PPI) from subscribable content previously downloaded and stored on computing device 102 to ascertain whether the PI is different than the PPI. If the PI is different, then current subscribable content 204 is considered updated subscribable content. If the PI is not different, then current subscribable content 204 is not considered updated subscribable content. As shown, Web browser 110 can utilize the functionality of update and display module 112 to accomplish this processing, storing and/or determining.

If Web browser 110 determines that current subscribable content 204 represents updated subscribable content, it can notify a user of computing device 102 that the content that they have subscribed to has been updated and is available. As shown, Web browser 110 can utilize the functionality of update and display module 112 to accomplish notifying the user. Notifying can include, without limitation, bolding the PI, providing an icon on a tool bar of Web browser 110 or providing some other visual and/or audible indicia to the user.

Web source(s) 116 also includes a display Web page 208 which can be associated with the same Web source as Web page 202 and/or Web page 206, or a different Web source altogether. Web page 208 provides an instance 209 of current subscribable content 204. More particularly, Web page 208 includes annotation, such as HTML markup, which can be parsed by Web browser 110 or some other suitable application to discover instance 209. Instance 209 includes display information, such as display markup, for displaying current subscribable content 204 live from Web page 208. This can include displaying all or part of current subscribable content 204 on any suitable user interface surface such as, without limitation, in a preview or flyout window and/or as text on a “favorites” toolbar for example. Here it should be noted that Web page 208 may or may not have any content in common with Web page 202 and/or Web page 206 and the relationship of these Web pages is at the discretion of the content provider/publisher. As such, instance 209 and instance 205 may or may not include the same display and/or non-display information.

Instance 209 can be discovered and accessed by Web browser 110 utilizing, in at least some embodiments, functionality of update and display module 112. More particularly, recall that Web browser 110 can parse annotation of Web page 202, or of Web page 206, to discover and download instance 205. In a similar manner, Web browser 110 can also parse annotation of Web page 202, or update Web page 206, to discover a link to Web page 208 in the form of a URL for display Web page 208. Web browser 110 can then access display Web page 208 to retrieve or otherwise access instance 209. Web browser 110 can then utilize the display information of instance 209 to actively display current content 204 live on computing device 102. As shown, Web browser 110 can utilize the functionality of update and display module 112 to accomplish displaying current content 204.

Since instance 209 is dedicated to providing information for a single item of content, namely current subscribable content 204, and does not include aggregated extraneous content, it is not processed as instance 205 is. Therefore, display information such as script, ActiveX™ and the like is not removed from instance 209. As such, display information that would likely be removed if included in instance 205 can be provided to Web browser 110 by instance 209. This gives subscribable content providers significant control over how current content 204 is displayed or otherwise consumed because they are able to determine which display information is made available to Web browser 110. Furthermore, this can be accomplished using the existing Web page architecture. This display information availability allows for more enhanced display scenarios associated with increased interactivity and/or multi-step operations. By way of example and not limitation, this can include providing live user authentication, live location-based weather forecasting, live auction item previewing and bidding from the preview and other types of user interactions.

Web browser 110 can discover and access instance 209 at any suitable time. For example, in at least some embodiments, Web browser 110 discovers and accesses instance 209 in response to the occurrence of an event. Without limitation, such an event can include an action by the user associated with the subscribable content, such as selecting the updated content and/or Web browser 110 determining that current subscribable content 204 represents updated content.

It should be noted that while FIG. 2 is illustrated and described above in the context of a single update Web page, a single display Web page and two instances of the current subscribable content, this is not intended to be limiting. Therefore, it is to be appreciated and understood that any number of update Web pages, display Web pages and/or instances can be employed to implement the described live display techniques without departing from the spirit and scope of the claimed subject matter.

Furthermore, while FIG. 2 is illustrated and described above in the context of an update Web page that is distinct from a display Web page, it is to be appreciated and understood that a Web page or other source that includes both subscribable content and display information can be employed to implement the described techniques without departing from the spirit and scope of the claimed subject matter.

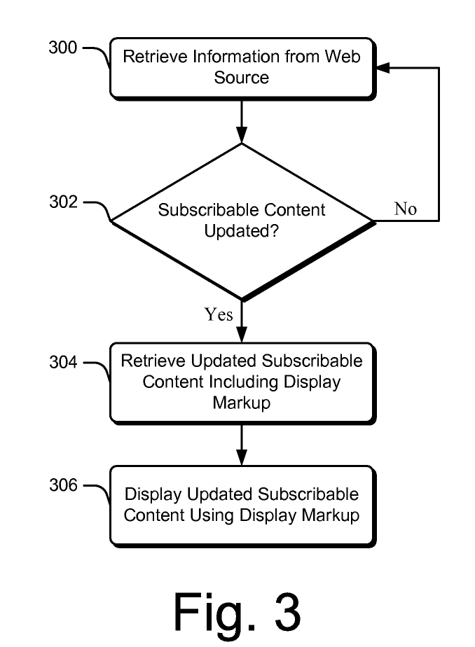

FIG. 3 illustrates a flow diagram that describes steps in a method in accordance with one or more embodiments. The method can be performed in connection with any suitable hardware, software, firmware or combination thereof. In at least some embodiments, the method can be performed by a suitably configured Web browser, such as Web browser 110 illustrated and described above.

Step 300 receives, from a Web source, information associated with subscribable content. This received information can include non-display information with a reference to a location, such as a display Web page, where subscribable content with display markup can be obtained. For example, in the context of FIGS. 1 and 2, instance 205 of current subscribable content 204 is downloaded by Web browser 110 from Web page 202 or from Web page 206.

Step 302 determines from the received information if the subscribable content has been updated. For example, in the context of FIGS. 1 and 2, subscribable current content 204 is downloaded on computing device 102 and processed to remove display information, resulting in the PI. The PI is then compared to the PPI to determine whether or not current subscribable content 204 represents updated subscribable content.

If step 302 determines that the subscribable content has been updated (i.e., “Yes”), the method proceeds to step 304 described below. However, if step 302 determines that the subscribable content has not been updated (i.e., “No”), the method can return to step 300 which can then be repeated any number of times, at any suitable frequency. In at least some embodiments, this frequency can be adjusted by a user.

Step 304 retrieves updated subscribable content including display markup. This updated subscribable content can be retrieved from the location referenced in the information received at step 300. As described above, this location can be a display Web page. For example, in the context of FIGS. 1 and 2, instance 205 of current subscribable content 204 is downloaded on computing device 102. Recall that this instance of downloaded content can include non-display information and display information in the form of display markup. This display markup, however, is removed during processing and is therefore unavailable after Web browser 110 determines that current subscribable content 204 has been updated. Therefore, to actively display current subscribable content 204 live, Web browser 110 retrieves or otherwise accesses instance 209 of current subscribable content 204 from display Web page 208. Recall that instance 209 of downloaded content includes display information in the form of display markup for displaying current subscribable content 204.

Step 306 displays the updated subscribable content using the display markup retrieved at step 304. As such, the updated subscribable content can be displayed live in an interactive fashion. For example, in the context of FIGS. 1 and 2, current subscribable content 204 is actively displayed live from Web page 208 using the retrieved display markup of instance 209.

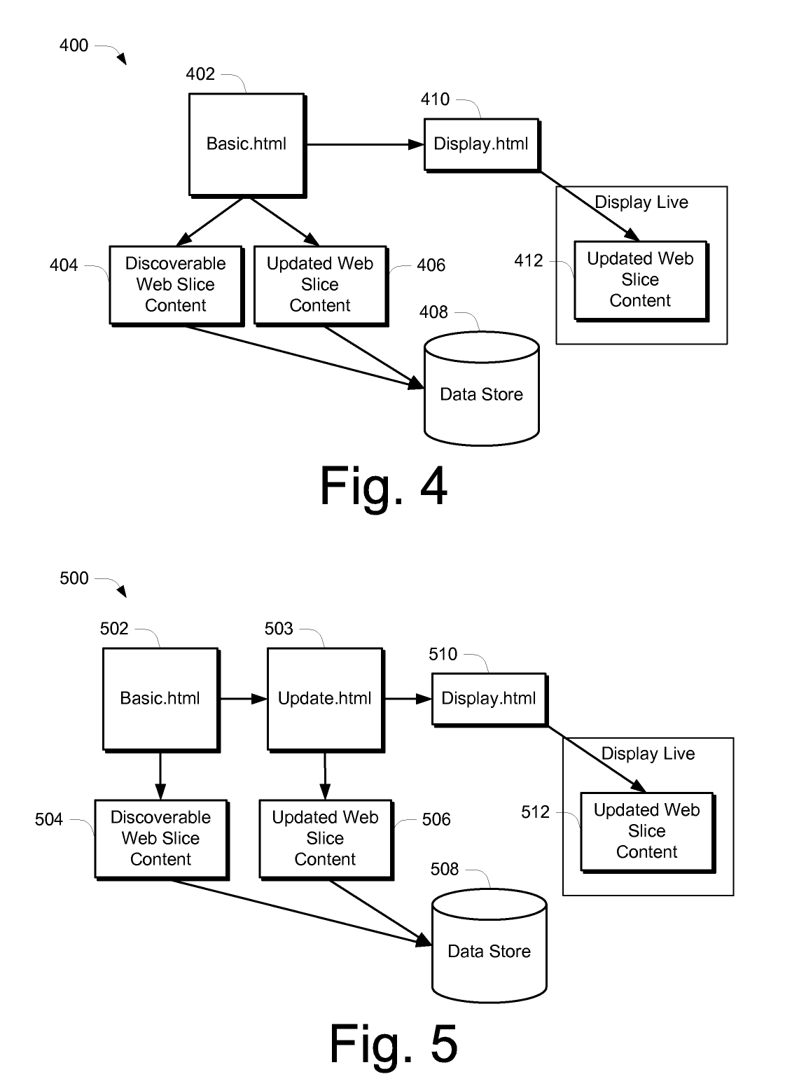

FIGS. 4 and 5 illustrate example embodiments for implementing the described live display techniques. For purposes of discussion, these embodiments are illustrated and described in the context of a Web slice. A Web slice can include one or more Web pages with parsable annotation, typically HTML markup code, allowing for the discovery, display and/or update of subscribable content. However, this is not intended to be limiting and it is to be appreciated and understood that various embodiments other than Web slice embodiments can be implemented according to the described techniques without departing from the spirit and scope of the claimed subject matter.

FIG. 4 illustrates example embodiment 400 which includes a Web page 402 defined by a Basic.html file of HTML markup code. Web page 402 is an original Web page by which a user can discover and subscribe to Web slice content, shown here as discoverable Web slice content and updated Web slice content. An instance 404 of discoverable Web slice content that is accessible to the user is provided by Web page 402. Instance 404 can include all or part of the HTML code of the Basic.html file associated with the Web slice content. In addition, a first instance 406 of updated Web slice content that is accessible to the user is also provided by Web page 402. First instance 406 can include all or part of the HTML code of the Basic.html file associated with updated Web slice content. As FIG. 4 shows, instances 404 and 406 can be downloaded, processed and stored in a data store 408 associated with the user's computing device. As described above however, display information of instances 404 and 406 is removed during processing.

Example embodiment 400 also includes a Web page 410 defined by a Display.html file of HTML markup code. Web page 410 is a display Web page for displaying the updated Web slice content. A second instance 412 of updated Web slice content with display information that is accessible to the user is provided by Web page 410. Second instance 412 can include all or part of the HTML code of the Display.html file associated with the Web slice content, including display markup. Since second instance 412 is not downloaded and processed like instances 404 and 406 to remove its display information, Web page 410 can be created and maintained specifically for display purposes—allowing a publisher significant control over how updated Web slice content is displayed to users.

In practice, the Basic.html code defining Web page 402 can be parsed by a Web browser, such as Web browser 110 above, to discover first instance 406 or to discover a URL for another Web page providing first instance 406. In this example, first instance 406 is provided by Web page 402 itself and there is no such URL in the Basic.html code. As such, the Web browser is able to discover and access the updated Web slice content in the Basic.html code itself. This can include downloading, processing and storing first instance 406 in data store 408. In addition to parsing the Basic.html code to discover first instance 406, the Web browser can also parse the Basic.html code to discover a URL for Web page 410. The Web browser can then access Web page 410 and parse its Display.html code to access second instance 412 and display the updated Web slice content.

Consider, for example, a scenario where the user receives a notification from the Web browser that the Web slice they have discovered and subscribed to has been updated. The user may then select the downloaded updated Web slice and, in response, the Web browser can parse the Basic.html code to discover the URL of Web page 410. The Web browser can then retrieve or otherwise access second instance 412 to display the updated Web slice.

As an example of a Basic.html file and a Display.html file, consider the following:

Basic.html:

```
...
<div class=“hslice” id=“auction”>
  <span class=“entry-title”>Auction Item</span>
  <a rel=”entry-content” href=“http://www.example.com/display.html”/>
</div>
```

Display.html:

```
...
<html>
  <body>
    <div> Current bid is $32</div>
  </body>
</html>
```

Note that in the Basic.html example above, “<div class=“hslice” id=“auction”>” indicates to a browser (or other suitable application) that Web slice (“auction”) content is available and can be subscribed to. Furthermore, “<a rel=“entry-content” ref=http://www.example.com/display.html/>” indicates that a separate display Web page (“www.example.com/display.html”) is available to display the Web slice. In this regard, the link from basic.html to display.html is represented by using the entry-content property and specifying the “rel” attribute (in this example, the value is “entry-content”) and “href” attribute (in this example, the value represents the location/URL of the display Web page).

FIG. 5 illustrates example embodiment 500 which includes a Web page 502 defined by a Basic.html file of HTML markup code. Web page 502 is an original Web page by which a user can discover and subscribe to Web slice content represented here by discoverable Web slice content and updated Web slice content. Similar to embodiment 400 above, an instance 504 of discoverable Web slice content that is accessible to the user is provided by Web page 502. Instance 504 can include all or part of the HTML code of the Basic.html file associated with the Web slice content. However, unlike embodiment 400, here update Web page 503, defined by an Update.html file of HTML markup code, provides a first instance 506 of updated Web slice content. First instance 506 can include all or part of the HTML code of the Update.html file associated with the updated Web slice content. First instance 506 can be made accessible to the user after the user has subscribed to and accessed instance 504.

In practice, a Web browser can parse the Basic.html code defining Web page 502 to discover the URL for update Web page 503 and then parse its Update.html code to access first instance 506. The Web browser can then download, process and store the updated Web slice content of first instance 506. This can include downloading, processing and storing first instance 506 in data store 508.

Example embodiment 500 also includes a Web page 510 defined by a Display.html file of HTML markup code. Web page 510 is a display Web page for displaying the updated Web slice content. A second instance 512 of updated Web slice content with display information that is accessible to the user is provided by Web page 510. Second instance 512 can include all or part of the HTML code of the Display.html file associated with the Web slice content, including display markup. Second instance 512 can be retrieved or otherwise accessed specifically for display purposes.

In practice, since update Web page 503 provides the updated content to the Web browser, the Update.html code can be parsed by the Web browser to discover the URL for display Web page 510. The Web browser can then access and parse the Display.html code of Web page 510 to access second instance 512 and display the updated Web slice content.

Consider, for example, a scenario where the user receives a notification from the Web browser that the Web slice they have discovered and subscribed to has been updated. The user may then select the downloaded updated Web slice and in response, the Web browser can parse the Update.html code to discover the URL of display Web page 510. The Web browser can then retrieve or otherwise access second instance 512 to display the updated Web slice. Alternatively or additionally, the Web browser can act in response to some other event, such as determining that the Web slice has been updated for instance.

As an example of a Basic.html file, Update.html file and Display.html file, consider the following:

Basic.html:
. . .
<div class=“hslice” id=“auction”>
<a rel=“feedurl” href=“http://www.example.com/update.html#auction-update”/>
<span class=“entry-title”>Auction Item</span>
   </div>
   Update.html:
   . . .
   <div class=“hslice” id=“auction-update”>
<h2 class=“entry-title”>Auction Item</h2>
   <p class=“entry-content”>Current bid is $32</p>
   <a rel=“entry-content” href=“http://www.example.com/display.html”/>
      </div>
      Display.html:
      . . .
      <html>
<body>
   <div>Current bid is $32</div>
</body>
   </html>

Note that in the Basic.html example above, “<div class=“hslice” id=“auction”>” indicates to a browser or other suitable application that Web slice (“auction”) content is available. Furthermore, “a rel=“feedurl” href=“http://www.example.com/update.html#auction-update”/” indicates that a separate update Web page (“www.example.com/update.html”) is available for providing updated Web slice content. The Update.html example, in turn, references/identifies the display Web page. More particularly, “<a rel=“entry-content” href=“http://www.example.com/display.html”/>” indicates that a display Web page (“www.example.com/display.html”) is available to display the Web slice.

Finally, recall from above that a Web page that includes both subscribable content and display information can be utilized to implement the described live display techniques. In at least some embodiments, this can be accomplished by using a Web slice Web page defined by an HTML file that references itself as an available Web page for displaying its updated Web slice content. In other words, the same Web source can be an update Web source and a display Web source for updated subscribable content. To further facilitate the reader's understanding of this concept, an example Update-and-display.html file is provided below:

Update-and-display.html:
. . .
<div class=“hslice” id=“auction-update”>
<h2 class=“entry-title”>Auction Item</h2>
<p class=“entry-content”>Current bid is $32</p>
<a rel=“entry-content” href=“http://www.example.com/update-and-display.html”/>
   </div>

Note that in the Update-and-display.html example above, “<a rel=“entry-content” href=“http://www.example.com/update-and-display.html”/>” references itself as being a display Web page available for displaying the updated Web slice content.

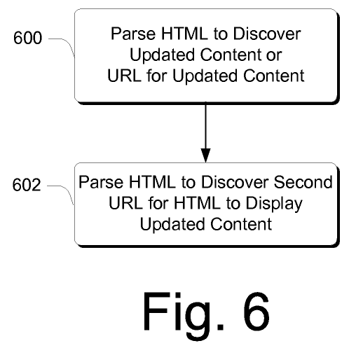

FIG. 6 illustrates a flow diagram that describes steps in a method in accordance with one or more embodiments. The method can be performed in connection with any suitable hardware, software, firmware or combination thereof. In at least some embodiments, the method can be performed by a suitably configured Web browser, such as Web browser 110 illustrated and described above.

Step 600 parses HTML code to discover updated content or a URL for providing the updated content. This updated content can be content to which a user has subscribed. For example, in the context of FIG. 4, the HTML code of the Basic.html file is parsed to discover updated content. In the context of FIG. 5 however, the HTML code of the Basic.html file is parsed to discover the URL of update Web page 503 which provides the updated content.

Step 602 parses HTML code to discover a second URL for providing display HTML useable to display the updated content. Note that the HTML parsed at this step may belong to the same file that includes the HTML code parsed at step 600, or to a different file. More particularly, if step 600 parses HTML code of a file to discover updated content, step 602 can also parse HTML code of that same file to discover a URL for providing display HTML. For example, in the context of FIG. 4, the HTML code of the Basic.html file can be parsed to discover the updated content and to discover the URL to display Web page 410. As such, with respect to this method, the same file parsed at step 600 is also parsed at step 602. Similarly, in the context of FIG. 5, the HTML code of the update.html file can be parsed to discover the updated content and to discover the URL to display Web page 510. As such, with respect to this method, the same file parsed at step 600 is also parsed at step 602.

If, however, step 600 parses HTML code of a file to discover a URL for providing the updated content, step 602 can parse HTML code of a different file to discover a URL for providing display HTML. For example, in the context of FIG. 5, the HTML code of the Basic.html file can be parsed to discover the URL of update Web page 503. The HTML code of the Update.html file can then be parsed to discover the URL to display Web page 510. As such, with respect to this method, the HTML file parsed at step 600 can be different than the HTML file parsed at step 602.

Live Web Slice Display-Example

Having considered the above discussion associated with displaying updated subscribable content, consider now an example embodiment in which a Web slice associated with a social networking Web page can be actively displayed on a Web browser tool bar live.

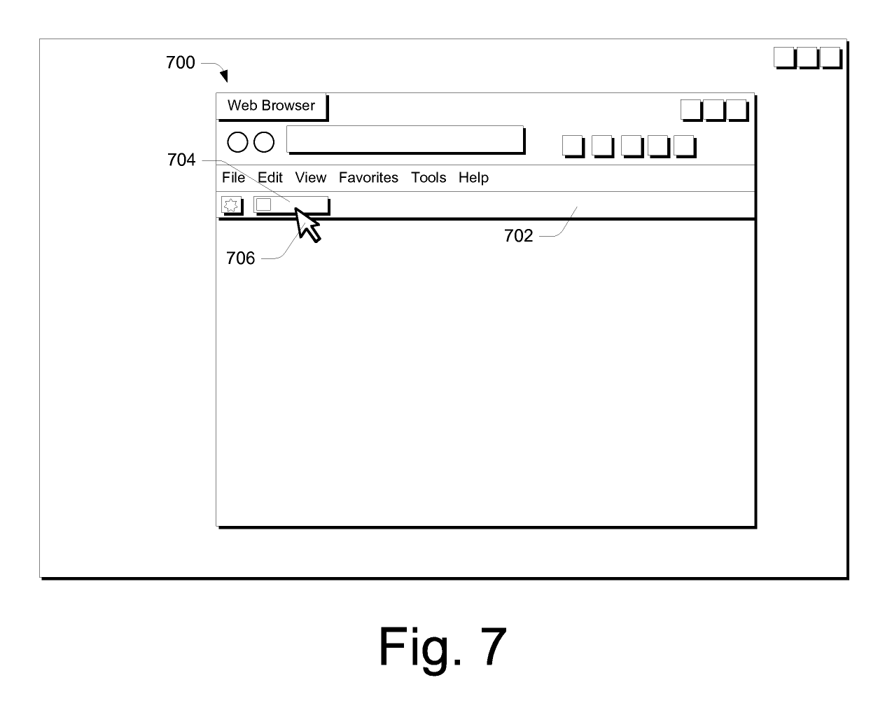

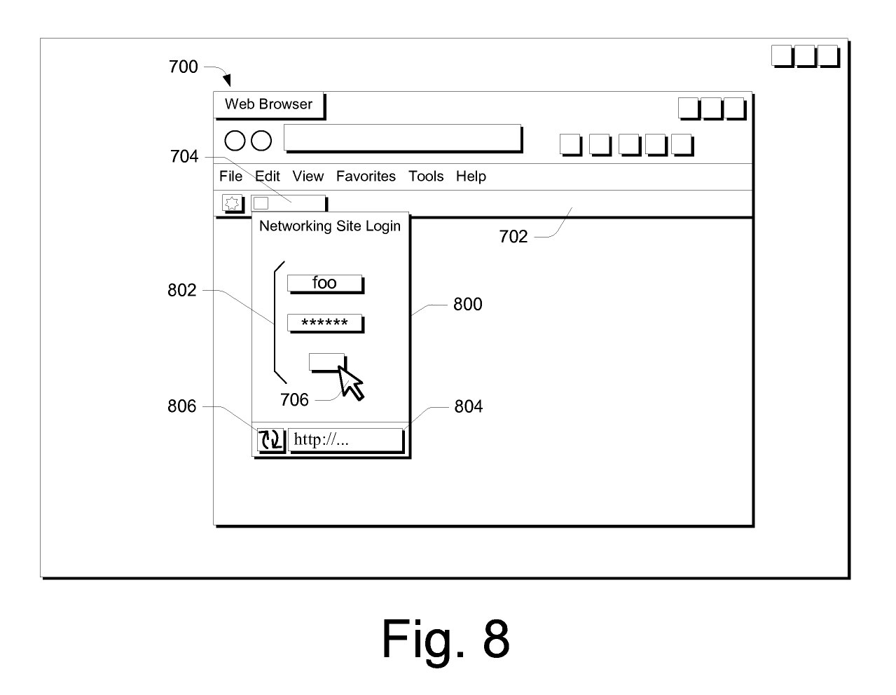

FIG. 7 illustrates a Web browser user interface (UI) generally at 700. In this example, user interface 700 includes a tool bar 702 on which a menu item 704 is displayed. Menu item 704 can include a drop-down menu and/or other menu item representative of a Web slice that a user has subscribed to. In this example, the Web slice is associated with a social networking Website. More particularly, the user has subscribed to the social networking Website such that certain user profiles of interest to the user can be displayed and interacted with locally on a computing device implementing the Web browser. As such, the user can utilize cursor 706, or some other selection item, to select menu item 704 causing a Web slice flyout window to be displayed. As an example, consider FIG. 8.

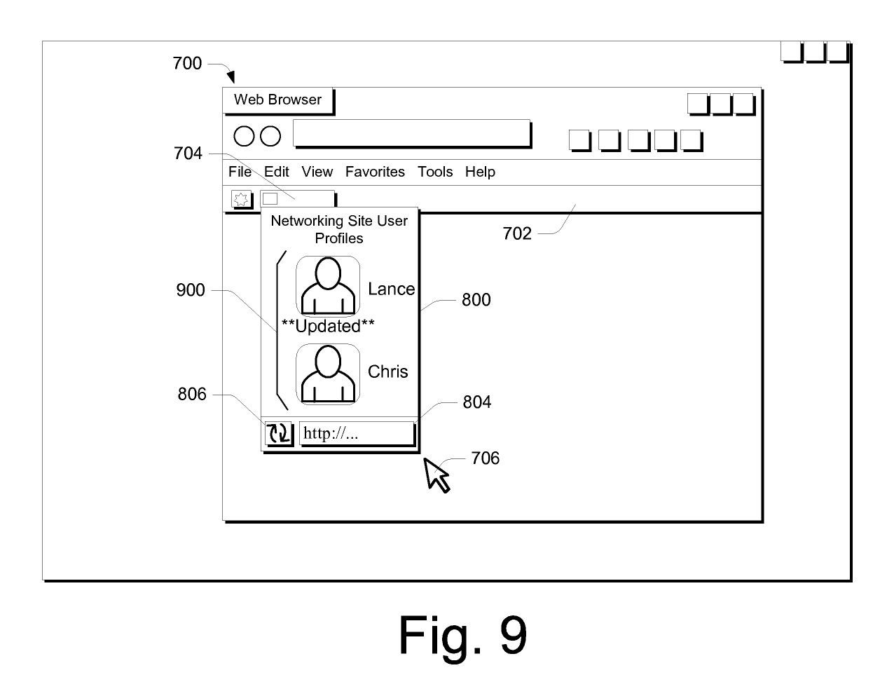

There, menu item 704 on tool bar 702 has been selected by the user via cursor 706 causing Web slice flyout window 800 to be displayed locally on tool bar 702 of Web browser UI 700. Note that here, by virtue of Web browser UI 700 being able to actively display updated Web slice content live (in window 800) in the context of how it is displayed/presented on a Web page for the Web slice, the user is able to interact with the content displayed in window 800 in a live fashion. For instance, here, an authentication login screen 802 is displayed in window 800 and the user is able to interact with it by entering their user login name (“foo”) and password (“******”) and then selecting a login button with cursor 706. An address bar 804 is also displayed which identifies the URL (“http// . . . ”) for the source of Web slice flyout window 800. This provides a security feature because the user is able to monitor the source of the information they are interacting with. In addition, a refresh button 806 is also displayed which the user can activate to refresh the source of the displayed Web slice content in Web slice flyout window 800. Assuming the user successfully authenticates, updated user profile information associated with user profiles of interest is then displayed in window 800. As an example, consider FIG. 9.

There, user profile information 900 is actively displayed in window 800 live. More particularly, here a profile for a user named Lance and a user named Chris are displayed. Furthermore, as this figure indicates, Lance's profile information has been updated and this updated profile information is actively displayed in window 800.

Example Device

FIG. 10 illustrates an example computing device 1000 that can be used to implement various described embodiments. Computing device 1000 can be, for example, computing device 102 of FIG. 1 and/or any other suitable computing device.

Computing device 1000 includes one or more processors or processing units 1002, one or more memory and/or storage components 1004, one or more input/output (I/O) devices 1006, and a bus 1008 that allows the various components and devices to communicate with one another. Bus 1008 represents one or more of any of several types of bus structures, including a memory bus or memory controller, a peripheral bus, an accelerated graphics port, and a processor or local bus using any of a variety of bus architectures. Bus 1008 can include wired and/or wireless buses.

Memory/storage component 1004 represents one or more computer storage media. Component 1004 can include volatile media (such as random access memory (RAM)) and/or nonvolatile media (such as read only memory (ROM), Flash memory, optical disks, magnetic disks, and so forth). Component 1004 can include fixed media (e.g., RAM, ROM, a fixed hard drive, etc.) as well as removable media (e.g., a Flash memory drive, a removable hard drive, an optical disk, and so forth). Component 1004 can be accessible by a computing device 1000 and/or by one or more additional devices as shared memory/storage.

One or more input/output devices 1006 allow a user to enter commands and information to computing device 1000, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules, such as update and display module 112 above for instance. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer(s).

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
receiving information associated with subscribable content from a Web source, wherein the received information includes a reference to a location outside of the Web source where display markup can be obtained, and wherein the display markup is configured to be used to display the subscribable content;
retrieving, from said location, the display markup; and
displaying the subscribable content using the display markup.

2. The computer-implemented method of claim 1, further comprising processing the information to remove different display markup from the information.

3. The computer-implemented method of claim 2, further comprising determining from the received information that the subscribable content has been updated by:
comparing processed information without display markup to previously downloaded information associated with the subscribable content; and
ascertaining that the processed information is different than the previously downloaded information.

4. The computer-implemented method of claim 1, wherein said acts of retrieving are performed responsive to an event associated with the subscribable content.

5. The computer-implemented method of claim 4, wherein the event comprises at least one of:
determining that the subscribable content has been updated; or
receiving a user action associated with the subscribable content.

6. The computer-implemented method of claim 1, wherein the method is implemented by a Web browser.

7. The computer-implemented method of claim 1, wherein the Web source comprises a first Web page with markup identifying the location, and wherein the reference comprises a Uniform Resource Locator (URL).

8. A computer-implemented method comprising:
processing a first instance of subscribable content to remove display information from the first instance;
determining, based at least in part on a processed first instance, that the subscribable content has been updated; and
responsive to an event, accessing a second instance of the subscribable content, the second instance including display information that can be used to display the second instance of the subscribable content.

9. The computer-implemented method of claim 8, wherein the first instance and the second instance are provided by different Web sources.

10. The computer-implemented method of claim 9, wherein the different Web sources comprise a first Web page for providing the first instance and a second Web page for providing the second instance.

11. The computer-implemented method of claim 10, wherein the first Web page includes markup identifying a Uniform Resource Locator (URL) for the second Web page.

12. The computer-implemented method of claim 8, wherein the event comprises receiving a user action associated with the subscribable content.

13. The computer-implemented method of claim 8, wherein determining comprises comparing a processed instance to a previously processed instance of the subscribable content.

14. The computer-implemented method of claim 8, wherein at least one of processing, determining or accessing is performed by a Web browser implemented on the device.

15. A system comprising:
one or more computer readable storage media;
computer readable instructions embodied on the one or more computer readable storage media which, when executed, implement a Web browser configured to:
parse HTML code to discover updated content to which a user has subscribed or a Uniform Resource Locator (URL) for providing the updated content; and
parse HTML code to discover a second URL for providing display HTML useable to display the updated content.

16. The system of claim 15, wherein the HTML code comprise a same file.

17. The system of claim 15, wherein the HTML code parsed to discover the updated content or a URL and the HTML code parsed to discover a second URL comprise different files.

18. The system of claim 15, wherein the Web browser is further configured to:
determine, based at least in part on the updated content, that the updated content is different from previous content to which the user subscribed; and
utilize the display HTML to display the updated content.

19. The system of claim 15, wherein the Web browser is further configured to parse HTML code to discover the second URL in response to an event.

20. The system of claim 19, wherein the event comprises at least one of:
a determination that the updated content is different from previous content to which the user has subscribed; or
a user action.
